(19) United States
(12) Patent Application Publication
(10) Pub. No.: US 2008/0108508 A1
(43) Pub. Date: May 8, 2008

(54) Fluorescent Phosphonic Ester Library

(75) Inventors: Albin Hermetter, Graz (AT); Hannes Schmidinger, Graz (AT); Gernot Riesenhuber, Graz (AT); Heidrun Susani-Etzerodt, Graz (AT); Ruth Birner-Grunberger, Hitzendorf (AT)

Correspondence Address: WORKMAN NYDEGGER, 60 EAST SOUTH TEMPLE, 1000 EAGLE GATE TOWER, SALT LAKE CITY, UT, 84111, US

(73) Assignee: TECHNISCHE UNIVERSITÄT GRAZ, Graz (AT)

(21) Appl. No.: 11/572,729

(22) PCT Filed: Jun. 6, 2005
(86) PCT No.: PCT/EP05/06042

§ 371 Date: Mar. 7, 2007

(30) Foreign Application Priority Data
Jul. 26, 2004 (AT) A 1273/2004

(51) Int. Cl. C40B 30/00; C40B 40/04

(52) U.S. Cl. 506/7; 506/15

(57) ABSTRACT

An assay library comprising 14 fluorescently labeled phosphonate esters which act as serine hydrolase inhibitors is provided as an analytical tool enabling activity based identification of serine hydrolases and characterization of enzyme preparations, protein mixtures and complex proteome samples.

Lipases and esterases catalyze the stereoselective hydrolysis of acylesters by a mechanism involving a nucleophilic serine in the active site (J. Kraut, Annual Review of Biochemistry 1977, 46 331-358). They are widely used in asymmetric syntheses and deracemisation reactions in organic chemistry and biotechnology (K. E. Jaeger et al., Current Opinion in Chemical Biology 2002, 13 390-397).

A large variety of lipases has been investigated and classified with respect to their substrate specificity, their sequence homology and structural identity (J. Pleiss et al., Chem. Phys. Lipids 1998, 93 67-80; R. J. Kazlauskas, Trends in Biotechnology 1994, 12 464-472; U. T. Bornscheuer, Current Opinion in Chemical Biology 2002, 13 543-547; U. T. Bornscheuer et al., Trends in Biotechnology 2002, 20 433-437; J. L. Arpigny et al., Biochem. J. 1999, 343 Pt 1 177-183; K. Amada et al., FEBS Letters 2001, 509 17-21). Most of the lipases have unique features like the α/β-hydrolase fold and a lid through which they exert substrate-mediated interfacial activation (N. Miled et al., Journal of Molecular Catalysis B: Enzymatic 2001, 11 165-171; D. L. Ollis et al., Protein Eng. 1992, 5 197-211; M. Martinelle et al., Biochimica et Biophysica Acta (BBA)—Lipids and Lipid Metabolism 1995, 1258 272-276; A. M. Brzozowski et al., Nature 1991, 351 491-494). There are several catalytical motifs, the most prominent being the G-X-S-X-G motif with a catalytical triad consisting of serine, histidine and aspartate. Although many of the lipases show strong structural and sequence similarities, their substrate and stereospecificities can alter significantly (H. Scheib et al., Protein Sci 1999, 8 215-221).

Esterases are enzymes cleaving carboxylesters other than triacyglycerols. They usually exhibit an α/β-hydrolase fold, but lacking the lid they do not show interfacial activation. Three of the esterases mentioned herein have been isolated from Burkholderia and Xanthomonas species and show special structural features. Two of them are α/β-hydrolase folded enzymes belonging to the G-D-S-L family, whereas the esterase from Burkolderia gladioli bears a class C β-lactamase and the S-x-x-K motif (J. L. Arpigny, K. E. Jaeger, Biochem. J. 1999, 343 Pt 1 177-183; E. I. Petersen et al., Journal of Biotechnology 2001, 89 11-25).

The elucidation of substrate binding of lipases and esterases was intensively investigated using alkyl phosphonates (C. M. Taylor et al., Journal of Molecular Catalysis B: Enzymatic 2001, 15 15-22; P. Stadler et al., Biochimica et Biophysica Acta (BBA)—Lipids and Lipid Metabolism 1996, 1304 229-244; T. Pietzonka et al., Bioorganic & Medicinal Chemistry Letters 1996, 6 1951-1954; O. V. Oskolkova et al., Chemistry and Physics of Lipids 2003, 125 103-114; M. L. M. Mannesse et al., Biochimica et BiophysicaActa (BBA)—Lipids and Lipid Metabolism 1995, 1259 56-64; M. P. Egloff et al., Biochemistry 1995, 34 2751-2762). If bound to the active site of the enzyme these phosphonates mimick the tetrahedral transition state of the scissile fatty acid component under nucleophilic attack by the nuceophilic serine in the active site of the enzyme. In contrast to the carboxylic tetrahedral transition state, which is easily cleaved by the addition of water, the alkyl phosphonate once attacked by the active serine irreversibly and covalently traps the enzyme by stabilizing this transition state. Thus, alkyl phosphonates are suicide inhibitors for serine hydrolases and therefore, can be helpful in unraveling serine hydrolase activity (P. Stadler et al., Biochimica et Biophysica Acta (BBA)—Lipids and Lipid Metabolism 1996, 1304 229-244; O. V. Oskolkova et al., Chemistry and Physics of Lipids 2003, 125 103-114; M. L. M. Mannesse et al., Biochimica et Biophysica Acta (BBA)—Lipids and Lipid Metabolism 1995, 1259 56-64; O. V. Oskolkova et al., Biochimica et Biophysica Acta (BBA)—Protein Structure and Molecular Enzymology 2002, 1597 60-66).

To measure the extent of inhibition, assays based upon the release of p-nitrophenol during inhibitor-enzyme complex formation have been established (D. Rotticci et al., Biochimica et Biophysica Acta (BBA) 2000, 1483 132-140). Alternatively, the residual activity of the enzyme after a certain time of inhibition can be determined (P. Stadler et al., Biochimica et Biophysica Acta (BBA)—Lipids and Lipid Metabolism 1996, 1304 229-244; O. V. Oskolkova et al., Chemistry and Physics of Lipids 2003, 125 103-114; C. M. Taylor et al., Journal of Molecular Catalysis B: Enzymatic 2001, 15 15-22).

Although these methods are well established, a major drawback is their demand for purified enzymes to warrant that the release of p-nitrophenol or the residual activity originates from a single inhibited enzyme. Since most available enzyme preparations exhibit multiple lipolytic activities, they have to be purified prior to analysis. Secondly, considerable amounts of the probed enzymes are required.

These problems can be circumvented when fluorescent alkyl phosphonate derivatives are used. Pyrene, perylene, 7-nitro-benz-2-oxo-1,3-diazol (NBD) and rhodamine labeled alkyl phosphonate ester inhibitors of various types have already been synthesized (O. V. Oskolkova et al., Chemistry and Physics of Lipids 2003, 125 103-114; H. A. Berman et al., J. Biol. Chem. 1984, 260 3462-3468). NBD turned out to be very useful for fluorescent labeling due to its moderate price and its favorable emission properties (maximum emission at 540 nm, where biological background fluorescence in SDS-PAGE is already negligible).

The fluorescently labeled alkyl phosphonates do not only enable to detect formation of the inhibitor-enzyme complex in pure proteins, but also in complex proteome samples (R. Birner-Grunberger et al., Biotechnol. Bioeng. 2004. Jan. 20;85.(2):147.-54. 2004, 85 147-154; N. Jessani et al., Proc. Natl. Acad. Sci. U.S.A 2002. Aug. 6;99.(16.):10335.-40. 2002, 99 10335-10340; B. F. Cravatt et al., Current Opinion in Chemical Biology 2000, 4 663-668). The covalently bound inhibitors make the lipolytic enzymes visible on polyacrylamide gels and thus facilitate the selective analysis of the respective proteins in active form.

This applies, however, only to well-known inhibitor-enzyme complexes, i.e. to enzymes which are known to be inhibited by a specific phosphonate ester. The known methods do not allow to screen serine hydrolase activity in an undefined sample comprising an unknown number of (different) enzymes.

It is therefore the object of the present invention to provide a tool for serine hydrolase activity based identification and characterization of enzyme preparations, protein mixtures and complex proteome samples.

A further object is a process for discriminating serine hydrolase activities using the tool according to the invention.

The first object is achieved by an assay library comprising the following fluorescently labeled phosphonate esters:

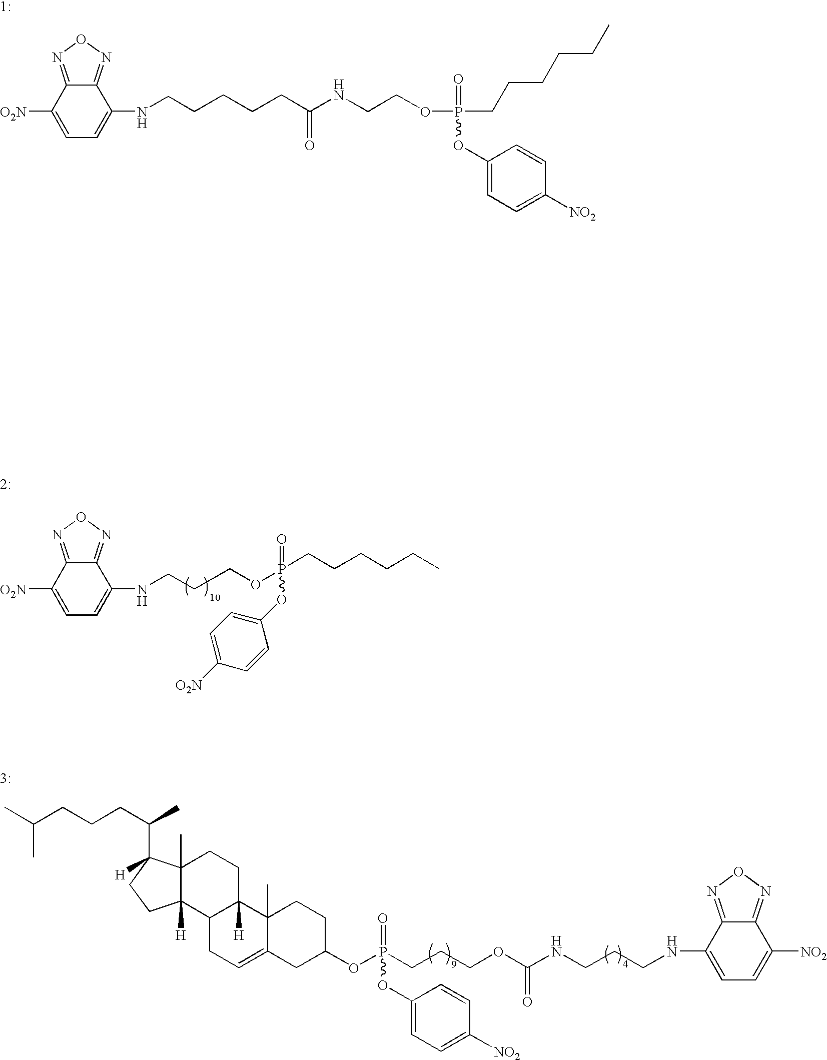

4: S-configurated (sn1) diastereomer

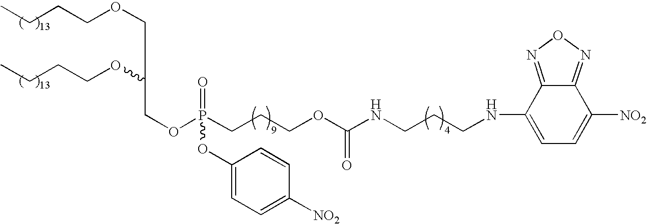

5: R-configurated (sn3) diastereomer

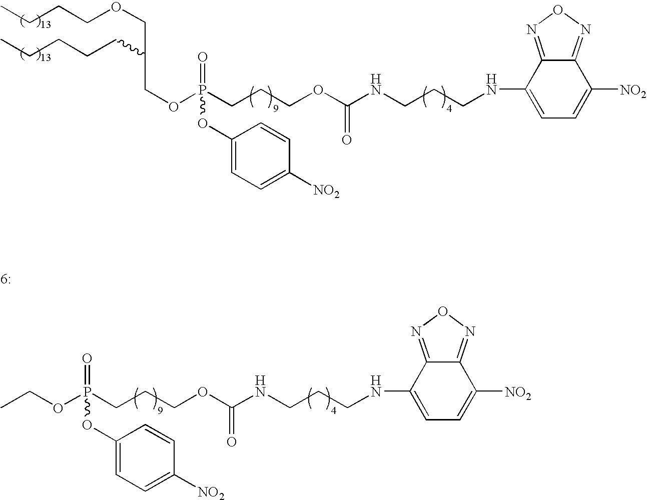

7: S-configurated (sn1) diastereomer

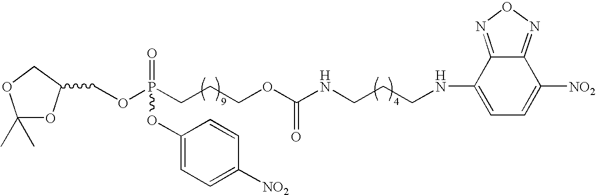

8: R-configurated (sn3) diastereomer

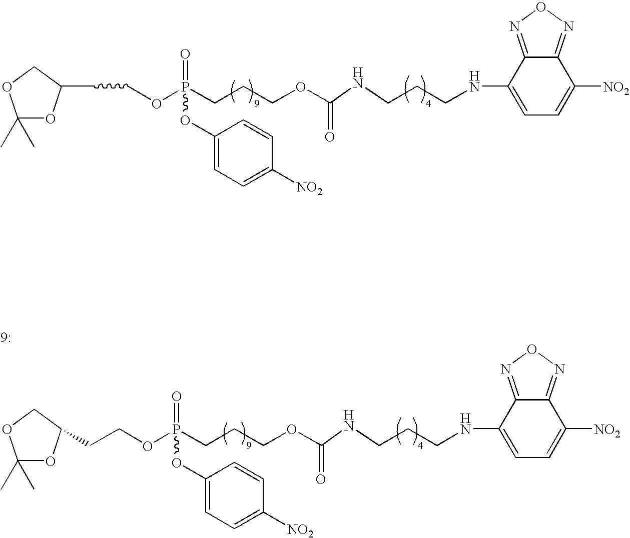

10: S-configurated diastereomer

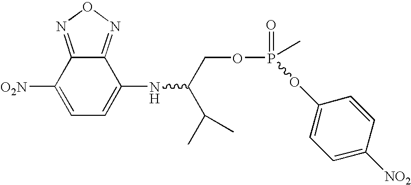

11: R-configurated diastereomer

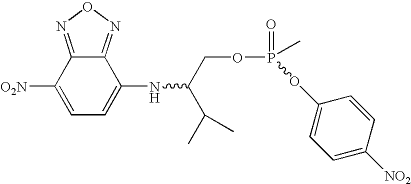

12: S-configurated diastereomer

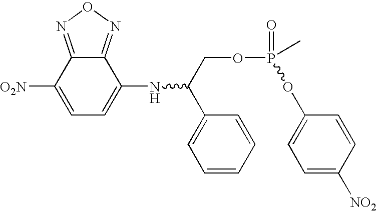

13: R-configurated diastereomer

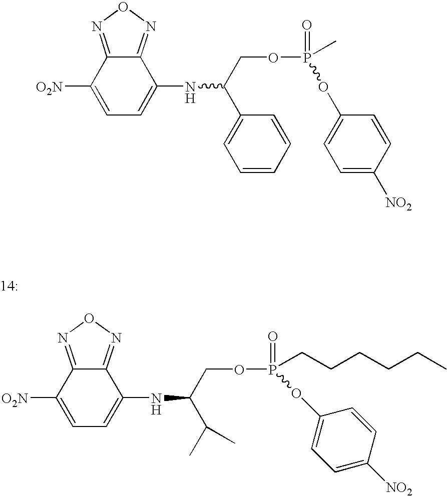

Another aspect of the invention relates to the use of the inventive assay library for activity based identification and characterization of serine hydrolases, preferably lipases and/or esterases.

The further object of the invention is achieved by a process for discriminating serine hydrolase activities, in particular lipase and esterase activities, which comprises the steps of incubating the fluorescently labeled phosphonate esters of the assay library according to the invention individually with an enzyme sample to be probed in the presence of a detergent (1 mM Triton X-100), subjecting the mixture to SDS-PAGE and imaging fluorescence to determine the extent of enzyme inhibition.

The process of exhaustively screening serine hydrolase activity in an undefined sample is tightly connected with the application of different inhibitors addressing different enzyme species. Accordingly, the inhibitor phosphonate esters of the assay library according to the invention were designed such that they would account for a large variety of serine hydrolases acting on a wide range of carboxylic esters displaying different structures, polarity, and stereochemistry.

Two different established strategies were used to prepare the phosphonate library of the present invention. In a first approach, the fluorescent tag is located at the alcohol side of the inhibitor, see scheme 1A below. In a second approach, the N-hydroxysuccinimidic acid ester (NHS) moiety in ω-position relative to the phosphorus atom paved the way to label the inhibitors at the phosphonic acid part after ester exchange (scheme 1B).

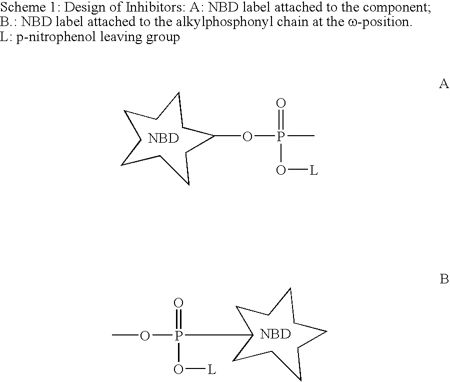

According to the first approach, the NBD-labeled alcohols 16-20 or the amido-alcohol component 15, respectively, were used together with unlabeled phosphonic acid dichlorides (K. Zhaoet al., Tetrahedron 1993, 49 363-368). The bulky, polar alcohol components of the library were synthesized using (R,S)-valinol and (R,S)-phenylalaninol which are both commercially available. The amino alcohols were converted with NBD-chloride yielding the pure NBD-labeled alcohols after flash chromatography. Alcohol 15 was obtained by the reaction of N-hydroxysuccinimide-activated NBD-N-hexanoic acid with 2-aminoethanol. It features a polar amide bond in vicinity to the alcohol functionality, whereas 12-aminododecanol, when reacted with NBD-chloride, yielded derivative 20 of similar chain length, but without the amide-bond, as depicted in scheme 2. Subsequently, the fluorescent alcohols 16-19 were dissolved in dry dichloromethane, and N-methylimidazol, 1H-tetrazole and methylphosphonic dichloride was added. After stirring for 3 h, an excess of 4-nitrophenol was added and the mixture was stirred over night. The short-chain methyl phosphonate derivatives 10-13 were isolated in low yields after evaporation of the solvents followed by flash chromatography. The same reaction was carried out with the alcohols 15,16 and 20 and hexylphosphonic dichloride. The obtained medium-chain inhibitors 1, 14 and 2 were isolated from the reaction mixture in moderate yields.

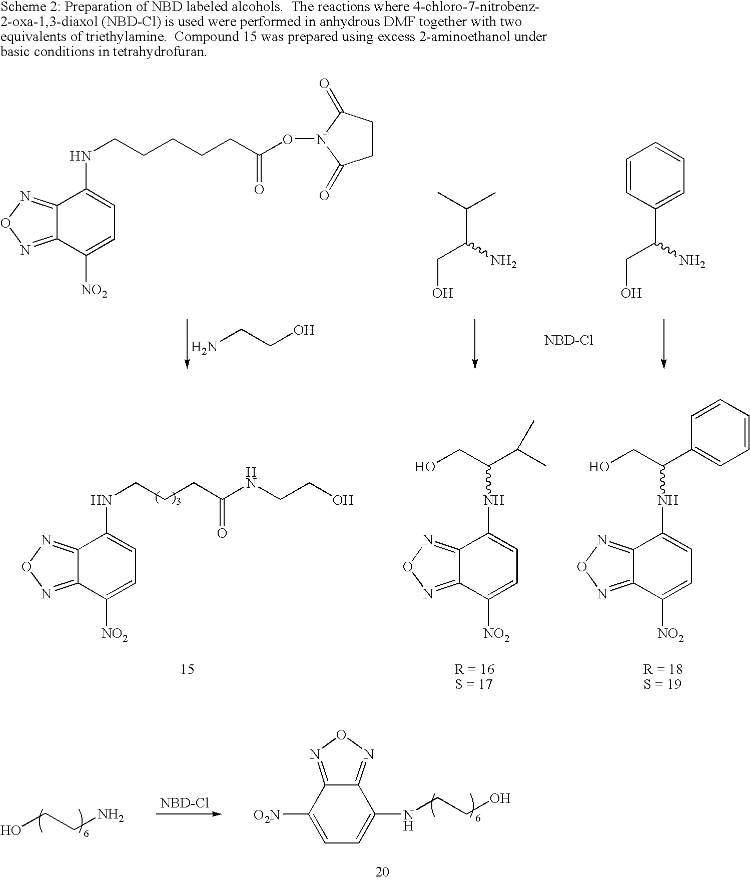

According to the second approach, compound 27 served as the phosphonic acid part of the inhibitors. The unlabeled alcohol components 21-26 were reacted with the ester moiety of compound 27, which has been synthesized according to literature (M. T. Reetz et al., Tetrahedron 2002, 58 8465-8473). The ester exchange was performed by first converting the p-nitrophenyl-ethyl-phosphonate into its trimethylsilyl derivative using a 6-fold excess of trimethylsilylbromide in dry dichloromethane. After evaporation of all volatile components, the crude product was then converted to the monochloride by addition of oxalylchloride and catalytical amounts of N,N′-dimethylformamide (DMF) to a dry dichloromethane solution of the trimethylsilylester. The chloride was converted to the respective ester by stirring of a solution of the chloride, the alcohol of interest and excess triethylamine in dry dichloromethane overnight. On the next day, the solvent was removed and the intermediate product was purified via flash chromatography. Subsequently, the NHS-activated phosphonates were coupled with the fluorophore-containing group 28 under basic conditions in dry DMF. Purification of the products by flash chromatography gave compounds 3-9 in moderate yields (scheme 3).

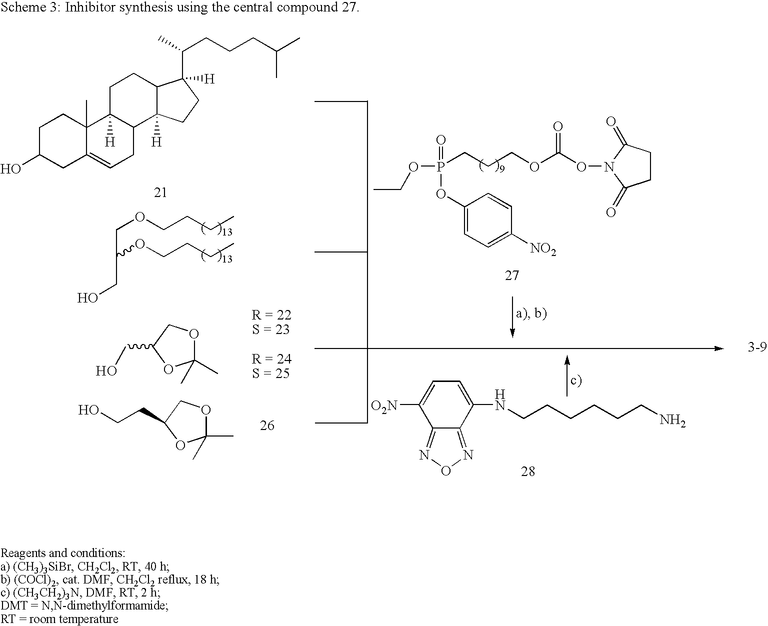

The complete list of inhibitors is shown in Table 1. The spectral characteristics of the inhibitor library components were determined in anhydrous DMF. The λ_{max.} of the absorption spectra was between 469 and 482 nm, and λ_{max.} of the emission spectra was between 529 and 545 nm (see Examples section, Table 2). All compounds are racemic at phosphorous. The detailed procedures regarding inhibitor synthesis and characterization are given in the Examples section.

Activity of the inhibitors towards a set of 19 serine hydrolases was systematically investigated (see Table 3). Activity was determined as the ratio of bound inhibitor to total protein in a band (NBD-fluorescence/Ruthenium (II) tris (bisbathophenanthroline disulfonate (RuBPS) fluorescence intensity) [T. Rabilloud et al., Proteomics 2001, 1 699-704]. In Table 3, these ratios are expressed in percent in comparison with the highest NBD/RuBPS ratio for each dataset (1 band, 14 inhibitors).

Solubilization of the inhibitor, especially of the very hydrophobic derivatives 3, 4 and 5, turned out to be a critical point. In order to keep the incubation assay simple, a Triton X-100 Tris/HCl buffer system was used (R. Birner-Grunberger et al., Biotechnol. Bioeng. 2004. Jan. 20;85.(2):147.-54. 2004, 85 147-154). Preliminary experiments had shown that a Triton X-100 concentration of 1 mM is mandatory for proper enzyme labeling. An increase of detergent concentration above 2 to 4 mM, depending on the probed enzyme, resulted in a decrease of labeling efficiency, for reasons yet unknown. In this study, all experiments were performed at a Triton X-100 concentration of 1 mM to maintain standard reaction conditions for inhibitor-based enzyme screening.

Overall three groups of NBD-labeled inhibitors were prepared using the two approaches described above. These compounds are characterized by the alkylphosphonyl residue differing in chain length, corresponding to acyl cains in carboxylic acid ester substrates, and alcohol components of varying polarity. The first two groups comprise inhibitors, wherein methyl- or hexylphosphonic acid dichloride was used for syntheses, and the alcohol component of the inhibitor was fluorescently derivatized. For Inhibitors 10-14, the aromatic system of the NBD dye was introduced in the vicinity of the reactive phosphorous to emphasize stereochemical discrimination in the active site of an enzyme. In contrast to the first two groups, inhibitors of the third group are labeled at the ω-position relative to the reactive phosphorus atom of the alkylphosphonic acid moiety. Therefore, the latter group of inhibitors are synthesized using unmodified alcohols such as both enantiomeres of 1,2 (2,3) di-O-hexadecyl-sn-glycerol which were used in order to address the regio- (stereo) selectivity of lipases hydrolyzing neutral lipids.

A study was performed in order to examine the interaction of the synthesized inhibitor library with serine hydrolyzing enzymes of various kinds and sources. To get an broad overview of the inhibitory potency of the library the inhibitors were tested on diverse serine hydrolase activities originating from lipases, esterases, a cutinase from Fusarium solari, and cholesterol esterases from bovine and porcine pancreas, respectively.

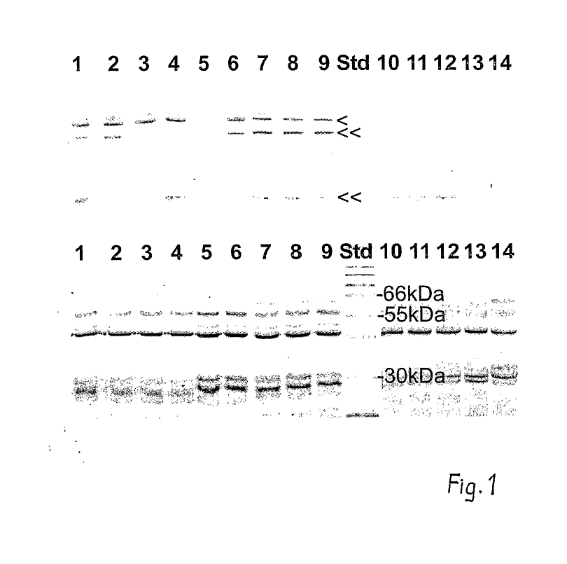

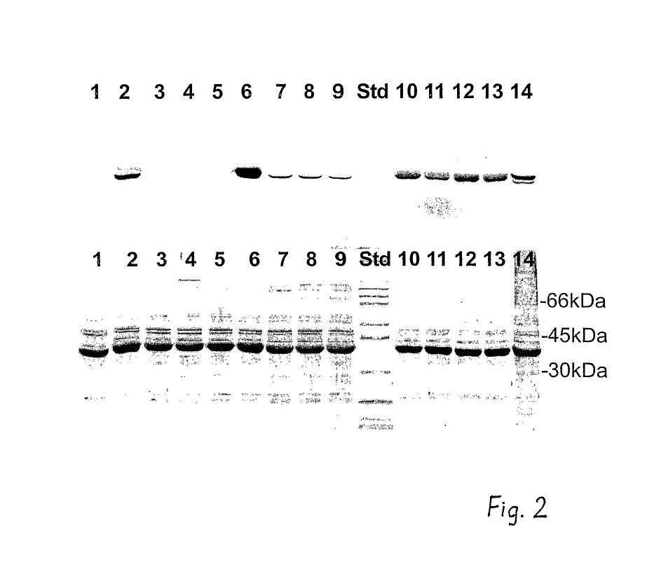

The enzymes were probed with the respective inhibitor at a final concentration of 50 μM in a Tris-HCl Triton X-100 buffer system at 37° C., as described in the Examples section. The reaction was stopped by heating the mixture with SDS-PAGE loading buffer and the sample was subjected to 1D SDS-gel electrophoresis. After protein separation the fluorescence intensity was measured using a laser gel scanner from Bio-Rad. The activity pattern of the inhibitors probing bovine pancreatic cholesterol esterase and esterase B from Burkholderia gladioli are depicted in FIGS. 1 and 2, respectively.

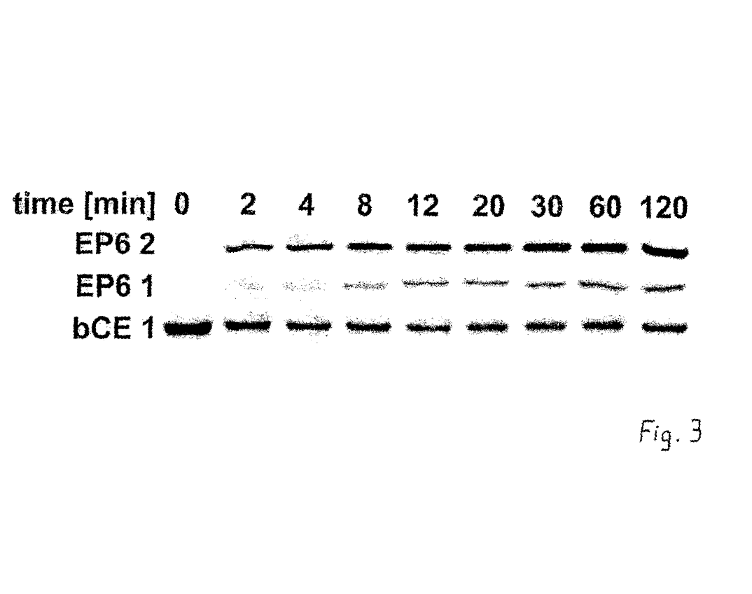

Furthermore, the time dependent formation of the enzyme inhibitor complex was determined for EP6 (Burkholderia gladioli esterase B) using inhibitor 1 and 2, and for means of comparison, for bovine cholesterol esterase using inhibitor 1 (see FIG. 3).

The process of exhaustively screening serine hydrolase activity in an undefined sample is tightly connected with the application of different inhibitors addressing different enzyme species. Therefore, the analysis of enzyme activity towards the new inhibitor library was extended to 19 enzymes originating from various microbial and vertebrate sources. Table 3 indicates that activity towards a single inhibitor strongly depends upon the probed enzyme, and that none of the inhibitors is labeling all of the enzymes.

### EXAMPLES

Chemicals for the inhibitor synthesis were purchased from Aldrich (Germany) and used without further purification. Flash chromatography was carried out on silica gel 60 (0.040-0.063 mm), TLC was performed on UV active TLC aluminium sheets coated with silica gel 60 F₂₅₄, both from Merck.

Adsorption and emission spectra were measured in microtiter plates with a Spectra MAX GEMINI EM fluorimeter from Molecular Devices.

NMR-Spectra were recorded with a Bruker VARIAN INOVA-500.

TABLE 2
Absorption and Emission data of the inhibitors

| Compound | λ_{max.} absorption [nm] | λ_{max.} emission [nm] |
|---|---|---|
| 1 | 471 | 531 |
| 2 | 471 | 532 |
| 3 | 469 | 531 |
| 4 | 471 | 529 |
| 5 | 475 | 534 |
| 6 | 476 | 532 |
| 7 | 476 | 533 |
| 8 | 472 | 533 |
| 9 | 478 | 533 |
| 10 | 482 | 542 |
| 11 | 480 | 540 |
| 12 | 482 | 545 |
| 13 | 482 | 538 |
| 14 | 482 | 538 |

### Inhibitor Syntheses:

N-(2-hydroxyethyl)-6-[(7-nitrobenz-2-oxa-1,3-diazol-4-yl)amino]hexanamide 15

12.5 mg (32.0 μmol) succinimidyl 6-(N-(7-nitrobenz-2-oxa-1,3-diazol-4-yl)amino)hexanoate are dissolved in 2 mL THF abs. To this solution, 7 μL (116.0 μmol) freshly distilled 2-aminoethanol is added. After 2 hours all volatile components are evaporated under reduced pressure, the residue is solubilized in 5 mL CHCl₃/MeOH/H₂O 65:25:4, and incubated with Dowex 50W×8 (H⁺-form, 200-400 mesh) for 30 minutes. The ion exchange material is filtered off and the filtrate is brought to dryness yielding pure 15. R_{f}=0.4 using CHCl₃/MeOH/H₂O65:25:4; yield: 99%.

### General Procedure for Compounds 16-20

100 mg (501.1 μmol) of 4-chloro-7-nitrobenz-2-oxa-1,3-diazole are dissolved together with 2 equivalents of triethylamine in DMF abs. To this solution, 1 equivalent of the respective aminoalcohol is added. After 2 hours all volatile components are removed under reduced pressure, and the residue is purified by flash chromatography using CH₂Cl₂/MeOH 15:1 for 16 and 17, CH₂Cl₂/EtOAc 1:1 for 18 and 19, and CHCl₃/EtOAc 88:12 for compound 20.

16: ¹H-NMR (CDCl₃ 500 MHz): δ1.07 d(3H), δ1.09 d(3H), δ2.17 m(1H), δ2.72 bs(1H), δ3.72 bs(1H), δ3.98 m(2H), δ6.27 d(1H), δ6.75 d(1H), δ8.39 d(1H); ¹³C-NMR (CDCl₃ 125 MHz): δ19.3, 19.6, 29.9, 30.1, 61.7, 62.4, 123.1, 137.2, 144.0, 144.6, 145.1; R_{f}=0.4, yield: 27.0%

17: ¹H-NMR (CDCl₃ 500 MHz): δ1.05 t(6H), δ2.15 m(1H), δ3.28 bs(1H), δ3.73 bs(1H), δ3.98 dd(2H), δ6.27 d(1H), δ7.01 bs (1H), δ8.34 d(1H); ¹³C-NMR (CDCl₃ 125 MHz): δ19.3, 19.5, 29.9, 30.1, 62.0, 62.3, 122.5, 137.5, 144.0, 144.5, 145.5; R_{f}=0.4, yield 18.2%

18: ¹H-NMR (CDCl₃ 500 MHz): δ3.01 m(2H), δ3.78 dd(J=4.1 Hz, 1H), δ3.85 dd(J=4.1 Hz, 1H), δ4.06 bs(1H), δ6.04 d(1H), δ6.49 bd(1H), δ7.16-7.3 m(5H), δ8.29 d(1H); ¹³C-NMR (CDCl₃ 125 MHz): δ29.92, 37.38, 56.73, 62.88, 127.55, 129.27, 129.47, 131.22, 136.49, 136.64, 143.81, 144.06, 144.54; R_{f}=0.4, yield: 5.6%

19: ¹H-NMR (CDCl₃ 500 MHz): δ3.02 m(2H), δ3.78 dd(J=4.2 Hz, 1H), δ3.88 dd(J=4.2 Hz, 1H), δ4.08 bs(1H), δ4.24 t(1H), δ6.04 d(1H), δ6.58 bd(1H), δ7.16-7.24 m(5H), δ8.29 d(1H); ¹³C-NMR (CDCl₃ 125 MHz): δ29.91, 37.99, 56.87, 62.88, 127.51, 129.29, 129.47, 131.22, 136.65, 136.75, 143.81, 144.06, 144.54; R_{f}=0.4, yield: 19.3%

20: ¹H-NMR (CDCl₃ 500 MHz): δ1.18-1.40 m(16H), δ1.51 q(2H), δ1.72 q(2H), δ1.84 bs(1H), δ3.45 bs(2H), δ3.34 t(2H), δ4.01 bs(1H), δ6.03 d(1H), δ8.30 d(1H); ¹³C-NMR (CDCl₃ 125 MHz): δ25.95, 26.85, 29.48, 29.62, 29.66, 29.68, 29.71, 29.77, 32.97, 56.30, 59.43, 63.16, 101.29, 121.70, 135.73, 144.64, 145.01, 145.76; R_{f}=0.40; yield: 58.2%

### General Procedure for Compounds 1-2, 10-14

The respective NBD-labeled amino alcohol is dissolved in absolute dichloromethane, after the addition of 5 equivalents of N-methylimidazol and 0.10 equivalents tetrazol, 3 equivalents of the respective dichlorophosphonate are added and the mixture is stirred for 3 h. Thereafter, 5 equivalents of 4-nitrophenol and N-methylimidazol are added together and the resulting mixture is stirred over night at room temperature. All volatile components are evaporated under reduced pressure, and the residue is purified by flash chromatography.

1: ¹H-NMR (CDCl₃ 500 MHz): δ=8.42 (d, 1H), 8.17 (d, 2H), 7.31 (d, 2H), 6.86 (bs, 1H), 6.23 (bs, 1H), 6.09 (d, 1H), 4.27-4.10 (m, 2H), 3.58-3.51 (m, 2H), 3.48-3.40 (m, 2H), 2.16-2.05 (m, 2H), 1.98-1.90 (m, 2H), 1.77-1.15 (m, 14H), 0.81 (t, 3H) MS, m/z (%):CHCl₃/MeOH 20:1; R_{f}=0.35, yield 14.0%

2: ¹H-NMR (CDCl₃ 500 MHz): δ=8.51 (d, 1H), 8.24 (d, 2H), 7.40 (d, 2H), 6.35 (bs, 1H), 6.19 (d, 1H), 4.19-4.05 (m, 2H), 3.53-3.47 (q, 2H), 1.99-1.91 (m, 2H), 1.85-1.78 (m, 2H), 1.74-1.59 (m, 5H), 1.51-1.22 (m, 21H), 0.90 (t, 3H); ¹³C-NMR (CDCl₃ 125 MHz): δ=156.1, 144.7, 144.5, 144.2, 136.8, 125.9, 124.1, 121.2, 98.7, 67.1, 44.2, 31.4, 30.7, 30.6, 30.4, 30.3, 29.9, 29.7, 29.6, 29.4, 29.2, 28.7, 27.1, 26.8, 25.7, 25.6, 22.6, 22.5, 22.4, 14.2; MS, m/z (%): CHCl₃/MeOH/Aceton 15:0.1:0.1 R_{f}=0.6; yield 17.0%

10: ¹H-NMR (CDCl₃ 500 MHz): δ1.09 m(6H), δ1.70 dd(J=16 Hz, 3H) δ2.15 m(1H), δ3.90 bs(1H), δ4.37 m(1H), δ4.49 m(1H), δ6.26 dd(J=8.2 Hz, 1H), δ6.77 dd(J=9Hz, 1H), δ7.28 d(1H), δ7.35 d(1H), δ8.09 d(1H), δ8.19 d(1H), δ8.42 t(1H); ¹³C-NMR (CDCl₃ 125 MHz): δ19.1, 19.3, 30.1, 121.1, 121.15, 121.2, 125.9, 126.0, 136.6, 144.13, 144.16, 155.0, 155.1, 155.2, 155.3; MS, m/z (%): CH₂Cl₂/MeOH 15:1 R_{f}=0.5, yield 23.4%

11: ¹H-NMR (CDCl₃ 500 MHz): δ1.01 m(6H), δ1.62 dd(J=16 Hz, 3H) δ2.05 m(1H), δ3.80 bs(1H), δ4.26 m(1H), δ4.40 m(1H), δ6.17 dd(J=8.2 Hz, 1H), δ6.83 d(1H), δ7.21 d(1H), δ7.28 d(1H), δ8.07 d(1H), δ8.14 d(1H), δ8.37 t(1H); ¹³C-NMR (CDCl₃ 125 MHz): δ19.1, 19.3, 30.1, 121.1, 121.15, 121.2, 125.9,126.0, 136.6, 144.13, 144.16, 155.0, 155.1, 155.2, 155.3; MS, m/z (%): CH₂Cl₂/EtOAc 4:1 R_{f}=0.5, yield 23.4%

12: ¹H-NMR (CDCl₃ 500 MHz): δ1.68 dd(J=17.3 Hz, 3H), δ2.97 m(2H), 84.22 m(3H), 6.08 dd(J=5.2 Hz, 1H), 6.84 d(1H), 7.24 m(5H), 7.32 d(2H), 8.16 d(2H), 8.33 dd(J=6 Hz, 1H); ¹³C-NMR (CDCl₃ 125 MHz): δ28.7, 30.9, 52.4, 59.4, 114.6, 119.89, 119.93, 119.97, 124.72, 124.76, 124.86, 125.18, 126.67, 126.68, 128.08, 128.17, 128.20, 134.21, 134.27, 134.73, 134.81, 142.78; MS, m/z (%): CH₂Cl₂/EtOAc 3:1 R_{f}=0.5, yield 3.8%

13: ¹H-NMR (CDCl₃ 500 MHz): δ1.68 dd(J=17.3 Hz, 3H), δ2.97 m(2H), δ4.22 m(3H), 6.08 dd(J=5.2 Hz, 1H), 6.84 d(1H), 7.24 m(5H), 7.32 d(2H), 8.16 d(2H), 8.33 dd(J=6 Hz, 1H); ¹³C-NMR (CDCl₃ 125 MHz): δ28.7, 30.9, 52.4, 59.4, 114.6, 119.89, 119.93, 119.97, 124.72, 124.76, 124.86, 125.18, 126.67, 126.68, 128.08, 128.17, 128.20, 134.21, 134.27, 134.73, 134.81, 142.78; MS, m/z (%): CH₂Cl₂/EtOAc 3:1 R_{f}=0.5, yield 2.9%

14: ¹H-NMR (CDCl₃ 500 MHz): δ1.09 m(9H), δ1.16-1.46 m(8H), δ1.48-1.65 m(2H), δ2.11 m(1H), δ3.86 bs(1H), δ4.32 m(1H), δ4.45 m(1H), δ6.24 dd(J=9.0 Hz, 1H), δ6.64 bd(1H), δ7.37 dd(J=8.3 Hz, 1H), δ8.22 dd(J=8.3 Hz, 1H), δ8.45 t(1H); ¹³C-NMR (CDCl₃ 125 MHz): δ14.17, 19.03, 19.27, 22.34, 25.41, 26.56, 30.46, 31.33, 53.44, 59.65, 121.17, 124.59, 125.82, 126.03, 136.33, 144.08, 144.56, 144.73, 144.85, 144.98, 155.20, 155.41, 156.00; MS, m/z (%): CH₂Cl₂/MeOH 20:1 R_{f}=0.8, yield 16.8%

### General Procedure for Compounds 3-9

60.2 mg (120 μmol) of compound 27 are dissolved in 5 mL CH₂Cl₂ and 55.1 mg (360 μmol) (CH₃)₃SiBr are added. After stirring for 40 h, all volatile components are removed under reduced pressure. The orange residue is dissolved in 10 mL CH₂Cl₂, 45.7 mg (360 μmol) oxalylchloride and 3 μL DMF are added, and the resulting mixture is kept on reflux for 18 h. All volatile components are removed under reduced pressure. The residue is dissolved again in 2 mL CH₂Cl₂ and 1 equivalent of the respective alcohol component is added together with 3 equivalents of triethylamine. After 8 h of stirring, the solvent is evaporated and the intermediate compound is subjected to flash chromatography. The purified intermediate is dissolved in 1.5 mL DMF (in acetonitrile for the compound 3), together with 3 equivalents of triethylamine. To this solution, 1 equivalent of compound 28 is added and the resulting mixture is stirred for 2 h, and afterwards purified via flash chromatography.

3: ¹H-NMR (CDCl₃ 500 MHz): δ0.65-2.07 m(71H), δ3.21 d(2H), δ3.51 q(2H), δ4.05 t(2H), δ4.37 m(1H), δ4.69 bs(1H), δ5.34 d(1H), δ6.18 d(1H) δ6.50 bs(1H), δ7.40 dd(2H), δ8.24 dd(2H), δ8.50 d(1H); ¹³C-NMR (CDCl₃ 125 MHz): δ42.6, 36.0, 36.6, 39.8, 23.0, 28.4, 44.0, 50.2, 56.4, 57.2, 65.4, 121.4, 126.0, 157.2, 126.4; m/z (%): R_{f}=0.7 using CH₂Cl₂/EtOAc 85:15; yield: 53.0%

4: ¹H-NMR (CDCl₃ 500 MHz): δ=8.42 (d, 1H), 8.15 (d, 2H), 7.33 (q, 2H), 6.50 (bs, 1H), 6.10 (d, 1H), 4.63 (bs, 1H), 4.29-4.23 (m, 1H), 4.18-4.07 (m, 1H), 4.04-3.94 (2H), 3.54-3.31 (m, 9H), 3,12 (d, 2H), 1.95-1.85 (m, 2H), 1.78-1.71 (m, 2H), 1.67-1.13 (m, 81H), 0.8 (t, 6H) ¹³C-NMR (CDCl₃ 125 MHz): δ=136.7, 125.9, 121.3, 72.1, 70.9, 69.5, 65.3,44.0, 40.7, 32.2, 30.8, 30.6, 30.2, 30.0, 29.9, 29.7, 29.6, 29.5, 29.3, 28.6, 26.3, 26.1, 25.6, 22.9, 22.4, 14.3; m/z (%): R_{f}=0.4 using CH₂Cl₂/EtOAc 88:12; yield: 33.0%

5: ¹H-NMR (CDCl₃ 500 MHz): δ=8.42 (d, 1H), 8.15 (d, 2H), 7.33 (q, 2H), 6.50 (bs, 1H), 6.10 (d, 1H), 4.63 (bs, 1H), 4.29-4.23 (m, 1H), 4.18-4.07 (m, 1H), 4.04-3.94 (2H), 3.54-3.31 (m, 9H), 3,12 (d, 2H), 1.95-1.85 (m, 2H), 1.78-1.71 (m, 2H), 1.67-1.13 (m, 81H), 0.8 (t, 6H) ¹³C-NMR (CDCl₃ 125 MHz): δ=136.7, 125.9, 121.3, 72.1, 70.9, 69.5, 65.3, 44.0, 40.7, 32.2, 30.8, 30.6, 30.2, 30.0, 29.9, 29.7, 29.6, 29.5, 29.3, 28.6, 26.3, 26.1, 25.6, 22.9, 22.4, 14.3; m/z (%): R_{f}=0.4 using CH₂C1₂/EtOAc 88:12; yield: 26.0%

6: ¹H-NMR (CDCl₃ 500 MHz): δ1.18-1.28 m(8H), δ1.35 s(3H), δ1.38-1.46 m(6H), δ1.51-1.60 m(8H), δ1.66 m(2H), δ1.81 m(2H), δ1.93 m( J=17 Hz, 2H), δ3.15 bs(2H), δ3.58 bs(2H), δ4.08 bt(2H), δ4.67 bs(1H), δ6.19 d(1H), δ6.63 bs(1H), δ7.38 d(2H), δ8.25 d(2H), δ8.48 d(1H); MS (70 eV), m/z (%): R_{f}=0.6 in CH₂Cl₂/EtOAc 3:1; yield: 80.1%

7: ¹H-NMR (CDCl₃ 500 MHz): δ1.24-1.34 m(14H), δ1.42 m(8H), δ1.55 m(6H), δ1.82 m(4H), δ1.99 m(2H), δ3.20 bs(2H), δ3.51 bs(2H), δ3.77 m(1H), δ4.05 m(4H), δ4.18 m(1H), δ4.30 m(1H), δ4.70 bs(1H), δ6.18 d(³J=8.9 Hz, 1H), 86.49 bs(1H), δ7.40 d(³J=6.9 Hz, 2H) δ8.24 d(³J=8.5 Hz, 2H), δ8.50 d(³J=8.9 Hz, 1H); MS (70eV), m/z (%): R_{f}=0.4 in CH₂Cl₂/EtOAc 3:1; yield: 40.6%

8: ¹H-NMR (CDCl₃ 500 MHz): δ1.24-1.34 m(14H), δ1.42 m(8H), δ1.55 m(6H), δ1.82 m(4H), δ1.99 m(2H), δ3.20 bs(2H), δ3.51 bs(2H), δ3.77 m(1H), δ4.05 m(4H), δ4.18 m(1H), δ4.30 m(1H), δ4.70 bs(1H), δ6.18 d(³J=8.9 Hz, 1H), δ6.49 bs(1H), δ7.40 d(³J=9.6 Hz, 2H) δ8.24 d(³J=8.5 Hz, 2H), δ8.50 d(³J=8.9 Hz, 1H); MS (70eV), m/z (%): R_{f}=0.4 in CH₂Cl₂/EtOAc 3:1; yield: 31.3%

9: ¹H-NMR (CDCl₃ 500 MHz): 81.20-1.38 m(14H), δ1.42 m(8H), δ1.58 m(6H), δ1.93 m(6H), δ2.04 m(2H), δ3.20 bd(2H), δ3.50 bd(2H), δ3.57 m(1H), 84.05 m(4H), δ4.19 m(1H), δ4.25 m(1H), δ4.69 bs(1H), δ6.18 d(³J=8.7 Hz, 1H), 86.51 bs(1H), δ7.40 d(³J=9.0 Hz, 2H) δ8.24 d(³J=8.5 Hz, 2H), δ8.51 d(³J=8.9 Hz, 1H); MS (70eV), m/z (%): R_{f}=0.4 in CH₂Cl₂/EtOAc 3:1; yield: 20.3%

N-(7-nitro-2,1,3-benzoxadiazol-4-yl)hexane-1,6-diamine (as TFA-salt) 28

1.26 g (5 mmol) BOC-diaminohexane hydrochloride are dissolved in 15 mL 10% Na₂CO₃ and 0.50 g (2.5 mmol) NBD-Cl are added. After stirring over night at room temperature 50 mL water is added and the product is extracted with 50 mL ether. The organic phase is washed 4 times with 10 mL brine, dried over Na₂SO₄, and purified by flash chromatography with CHCl₃/EtOAc 88:12. The BOC-protecting group of the purified intermediate is cleaved using 1 mL of freshly distilled trifluoro acetic acid at room temperature. After stirring over night, excess TFA is evaporated and the oily product is treated with ether to yield 423 mg in the form of orange crystals.

¹H-NMR (DMSO-d₆ 500 MHz): δ1.38 m(4H), δ1.53 m(2H), δ2.66 m(2H), δ2.79 m(2H), δ3.34 bd(2H), δ6.18 d(³J=8.9 Hz, 1H), δ7.82 bs(3H), δ8.51 d(³J=8.9 Hz, 1H), δ9.58 bs(1H); ¹³C-NMR (DMSO-d₆ 125 MHz): δ26.15, 26.55, 27.59, 28.12, 39.43, 43.91, 99.74, 117,35 q(¹J(C,F)=290 Hz), 121.18, 138.62, 144.82, 145.10, 145.87, 159.07 q(²J(C,F)=38 Hz); R_{f}=0.1 in CHCl₃/MeOH/aqu.NH₃(25%) 90:9:1; yield:43.1%

### Preparation of Inhibitor-Enzyme Complex

Stock solutions of the fluorescent inhibitors were prepared at a concentration of 0.1 nmol/μL in CHCl₃. Each enzyme was probed with 1 nmol of the respective inhibitor, equivalent to a 2-fold molar excess of inhibitor minimum. It was transferred together with 2 μL of a Triton X-100 solution (10 mM in CHCl₃) to a sterile 1.5 mL eppendorf tube. The organic solvent was removed in an argon stream and then dried for 30 minutes in vacuum. 20 μL of the respective enzyme solution was added to each tube, vigorously shaken for 2 minutes, spun down briefly, and incubated for 2 hours on an eppendorf thermomixer at 37° C. and 550 rpm. After incubation, 5 μL of sample loading buffer was added to each tube, the mixture was incubated for 5 minutes at 95° C., and subjected to SDS-PAGE (10% resolving, and 4.5% stacking gel) at 20 mA constant current. Gels were shaken for 30 min in fixing solution (10% ethanol, 7% acetic acid ) and the NBD fluorescence was imaged with a Bio-Rad FX pro plus molecular imager at λ_{EX}=488 nm, λ_{EM}=530±15 nm. Afterwards, gels were stained overnight using 200 mM Ruthenium (II) tris (bisbathophenanthroline disulfonate (RuBPS) in 10% ethanol, and destained with fixing solution for 2 hours prior to scanning. Proteins were visualized at λ_{EX}=488 nm, λ_{EM}=605±25 nm. All band intensities were analyzed with the Quantity One software (Bio-Rad, Germany).

Enzymes were used at the following concentrations:

| | Conc. | |
|---|---|---|
| enzyme | [μg · μL⁻¹] | buffer |
| Cholesterol esterase from bovine pancreas (bCE), Sigma | 0.24 | 0.1 M Tris/HCl pH 7.0, |
| Lot: 119H7405 | | 2 mM CaCl₂, 3 mM |
| Cholesterol esterase from porcine pancreas (ppCE), Fluka | 0.13 | TDOC |
| Lot: 414450/1 42302 | | |
| Lipase from procine pancreas (ppL), Sigma Lot: 031K7670 | 0.24 | 0.1 M Tris/HCl pH 8.0, |
| Colipase from porcine pancreas (pp-colipase), Sigma | 0.13 | 2 mM CaCl₂, 3 mM |
| Lot:22K4070 1 | | TDOC |
| Purified lipoproteinlipase from bovine milk (bLPL) | 0.01 | 0.1 M Tris/HCl pH 7.4 |
| Lipoproteinlipase from Pseudornonas species (psLPL), | 0.06 | |
| Sigma Lot: 85H261 | | |
| Purified cutinase from Fusarium solari (FSC), Plant | 0.51 | 0.1 M Tris/HCl pH 7.0 |
| Genetic Systems N.V. (Belgium), recombinant | | |
| Esterase EstB from Burkholderia gladioli (EP6), | 0.47 | |
| recombinant from E. coli | | |
| Purified lipase from Rhizopus oryzae (ROL), SanofiChimie | 0.08 | |
| Lipase Fongique NS MEO 709 | | |
| Purified lipase from Rhizopus oryzae clone L258F/L254F | 0.07 | |
| (ROL F), Recombinant from E. coli | | |
| Lipase from Pseudomonas species (PSL), Nagase ChemteX | 0.17 | |
| Ltd (Japan) | | |
| Lipase from Rhizomucor miehei (RML), Fluka Lot: | 0.51 | 0.1 M Tris/HCl pH 8.0 |
| 43578/1 696 | | |
| Esterase from Mucor miehei (MME), Fluka Lot: 10249/2 | 0.54 | |
| 12100 | | |
| Purified lipase from Pseudomonas cepacia (PCL) | 0.29 | |
| Purified lipase from Pseudomonas cepacia clone L287W | 0.78 | |
| (PCL W), recombinant from E. coli | | |
| Lipase A from Candida antarctica (CAL A), Fluka Lipase | 0.10 | |
| A Lot: 12067/1 20303028 recombinant from Aspergillus | | |
| oryzae | | |
| Lipase from Aspergillus niger (ANL), Amano Lipase A | 1.09 | |
| Lot: LL01508 | | |
| Esterase EstE from Xanthomonas vesicatoria (EX9), | 0.50 | |
| recombinant from E. coli | | |
| Esterase EstA from Burkholderia gladioli (EP10), | 0.50 | |
| recombinant from E. coli | | |
| Purified human platelet activation factor acetyl hydrolase | 0.50 | |
| (PAF-AH), recombinant from COS7-cells | | |

### Time Dependent Inhibition of EP 6 and bCE:

11 nmol of the respective inhibitor was transferred together with 22 μL of a Triton X-100 solution (10 mM in CHCl₃) to a sterile 1.5 mL eppendorf tube. The organic solvent was removed in an argon stream and then dried for 30 minutes in vacuum. 220 μL of the respective enzyme solution were preincubated at 37° C. for 5 minutes, and added to the tube afterwards. The samples were shaked, and aliquots of 20 μL were withdrawn at 0, 2, 4, 8, 12, 20, 30, 60 and 120 minutes. The aliquots were immediately added to 5 μL of 95° C. hot 5-fold concentrated SDS-PAGE sample buffer. After a 5 minute incubation at 95° C. the denatured samples were subjected to SDS-PAGE and processed as described above.

Protein concentrations were determined in microtiterplates using the Bio-Rad reagent assay according to Bradford, and bovine serum albumin for calibration.

### Results:

Testing the phosphonate library with a cholesterol esterase preparation from bovine pancreas (see FIG. 1):

The cholesterol esterase preparation contains several active enzymes. Besides cholesterol esterase(<) the most prominent activity originated from a protein 55 kDa in size(<<). Cholesterol esterase is active towards the majority of inhibitors representing the library, low activity was found using the inhibitor 5, and the short, bulky, inhibitors 10-14. Cholesterol esterase clearly labels the S_{c}(sn−1) configurated trialkylglycerol derivative 4 only. The other compounds of the enzyme preparation, which can be considered as impurities, give an interesting insight into the selectivity of the components of the library. In contrast to cholesterol esterase (<), a 55 kDa protein (<<) does not act on the cholesterol and triacylglycerol like inhibitors, respectively. Inhibitor 3, the cholesterol ester inhibitor, uniquely labels cholesterol esterase, marking it as a high specific affinity tag for cholesterol ester cleaving enzymes. The most abundant protein, as seen from the whole protein stain, is of about 46 kDa in size and is weakly labeled by inhibitors bearing a polar moiety next to the reactive phosphorus (1,7-13). A highly abundant 28 kDa (<<) protein is detected by all inhibitors, excluding the cholesterol ester analog.

Testing the phosphonate library with recombinant esterase B from Burkholderia gladioli (see FIG. 2):

Esterase B from Burkholderia gladioli (EP6) as a representative of the esterase family, was found to be highly active towards inhibitor 2 (54%) and 6 (100%), and to a lower extent, to inhibitors 10-14 which summarize the more hydrophilic inhibitors of the library. The latter are mimicking acetates and hexanoates of bulky NBD-amino alcohols. The cholesterol and triacylglycerol analogs do not react with this esterase. This finding is in accordance to literature positioning the range of EP6 activity to bulky acetates and even tertiary alcohols, but not to hydrophobic triglycerides (E. I. Petersen et al., Journal of Biotechnology 2001, 89 11-25. EP6 discriminates drastically between inhibitor 2 and 1. Whereas inhibitor 1 was found to be active towards most of the investigated lipases and esterases herein, EP6 is labeled poorly.

Time dependent formation of the enzyme inhibitor complex using inhibitor 1 and 2 (see FIG. 3):

EP6 is slowly inhibited by compounds 1 and 2. Although 2 shows 25-fold inhibition of EP6 after 2 h compared to 1, the progress of inhibition is comparable and can be well resolved within minutes. Detergents can reduce activity of enzymes drastically. It has been shown earlier, that 50 mM Triton X-100 can reduce EP6 activity to zero. Nevertheless, the retarded reaction towards inhibitor 1 cannot be deduced from buffer or detergent conditions, because inhibitor 2 and 6 are significantly more reactive under the same buffer conditions.

In contrast to EP6, the inhibition of bCE is much faster. Not only is the enzyme immediately labeled after addition to the inhibitor cocktail, but the time course indicates that after incubation at 37° C. for 2 h the fluorescence intensity slightly decreases. This might be due to chemical hydrolysis of the enzyme inhibitor complex, which could occur with prolonged incubation or enzyme denaturation.

Interaction of the inhibitor library with the serine hydrolyzing enzymes tested:

In general, inhibitor diastereomeres of 10-14, where the alcohol component is S configured are preferably attacked when using the described buffer conditions. In most cases, upon replacement of methyl phosphonic acid residue by its hexyl derivative (10→14), activity towards enzymes which already show reactivity to the methyl phosphonic acid esters is increased considerably.

The influence of polar moieties in the vicinity of the reactive phosphorous apart from diastereomerical considerations becomes evident when looking at the activity of EP6, FSC, EX9, and PAF acetylhydrolase towards inhibitor pair 1 and 2. Whereas EP6 and FSC are reactive towards the non amide inhibitor 2, labeling of EX9 and PAF acetylhydrolase predominantly occurs by incubation using the amide containing derivative 1.

The dialkylglycero-inhibitor diastereomers 4 and 5 exert very different reactivity. Inhibitor 4 representing the S_{C}-configuration at the glycerol backbone was found to be active on PSL, psLPL, MME, CAL A, ppCE and bCE, whereas the R_{C}-configurated glycerol analog was determined to bind only weakly to some enzymes (PCL W, PSL, MME). In contrast to the dialkylglycero-inhibitors, enzymes do not discriminate between the isopropylidenglycerol based derivatives 7-9. Enzymes which are inhibited by one of these inhibitors, also recognize other derivatives of this group.

It becomes evident that activity towards inhibitors is mainly determined through the length of the alkylphosphonic acid (10 to 13 compared with 14). Therefore, the influence of the alcohol residue can only be compared when looking at inhibitor-enzyme complexes with the same length of the alkylphosphonic acid moiety.

The data suggest that screening enzymes with only one of the inhibitors would result in an incomplete list of activities, as none of the inhibitors could label all 19 enzymes in a comparable good manner. Even more, considering a low active enzyme in a preparation, the selected inhibitor must have excellent labeling activity towards this enzyme in order to detect it reliably. Depending on the chemical structure of the inhibitor used, a general pattern of enzymes most probably captured can be preselected (see PAF-AH). The bulky short chain inhibitors 10-14 are preferably detecting esterase, PAF-AH activity, whereas the triacylglycerol mimicking inhibitor 4 unravels lipolytic activity. The cholesterol ester analog is uniquely attacked by cholesterol esterases, marking it as the most specific inhibitor of the library. Thus, the inhibitor library of the present invention is an important and useful tool for the identification of serine hydrolase activity in protein mixtures as well as complex proteome samples.

TABLE 3
Relative activities of lipolytic enzymes towards various inhibitors. The values
indicated for a given enzyme and a given inhibitor are expressed as percent of the maximum
activity observed with the “best inhibitor” for the same enzyme. Numbers indicate inhibitors
as depicted in Table 1.

| | Inhibitor Number | | | | | | | | | | | | | |
|---|---|---|---|---|---|---|---|---|---|---|---|---|---|---|
| | 3 | 4 | 5 | 7 | 8 | 9 | 1 | 2 | 6 | 14 | 10 | 11 | 12 | 13 |
| length of | C₁₁ | | | | | | C₆ | | | | C₁ | | | |
| P-alkyl | | | | | | | | | | | | | | |
| chain | | | | | | | | | | | | | | |
| PCL | 4 | 9 | 7 | 6 | 12 | 10 | 92 | 100 | 48 | 27 | 10 | 7 | 5 | 9 |
| PCL W | 52 | 58 | 48 | 26 | 34 | 15 | 75 | 100 | 15 | 68 | 30 | 38 | 99 | 38 |
| PSL | 29 | 88 | 18 | 32 | 70 | 100 | 84 | 100 | 92 | 9 | 98 | 11 | 34 | 11 |
| psLPL | 6 | 36 | 6 | 25 | 22 | 24 | 86 | 90 | 68 | 100 | 54 | 19 | 29 | 18 |
| MME | 7 | 69 | 46 | 86 | 100 | 100 | 69 | 72 | 70 | 6 | 0 | 0 | 1 | 1 |
| EP10 | 15 | 25 | 21 | 100 | 80 | 76 | 42 | 51 | 34 | 55 | 11 | 12 | 19 | 9 |
| EP6 | 1 | 1 | 3 | 10 | 10 | 9 | 2 | 54 | 100 | 15 | 22 | 13 | 22 | 14 |
| EX9 | 5 | 3 | 4 | 15 | 8 | 10 | 41 | 11 | 16 | 28 | 23 | 25 | 100 | 29 |
| CAL A | 24 | 60 | 2 | 7 | 9 | 4 | 78 | 100 | 25 | 8 | 6 | 2 | 16 | 2 |
| ANL | 16 | 20 | 17 | 41 | 50 | 42 | 100 | 29 | 49 | 37 | 6 | 6 | 7 | 5 |
| ROL | 2 | 41 | 4 | 68 | 100 | 84 | 69 | 70 | 56 | 34 | 23 | 4 | 77 | 21 |
| ROL F | 5 | 9 | 4 | 66 | 100 | 71 | 48 | 56 | 48 | 2 | 7 | 2 | 11 | 9 |
| bLPL | 1 | 1 | 1 | 70 | 72 | 69 | 42 | 29 | 37 | 42 | 100 | 16 | 76 | 23 |
| FSC | 7 | 32 | 14 | 73 | 76 | 75 | 42 | 95 | 82 | 34 | 98 | 91 | 90 | 100 |
| ppCE | 73 | 78 | 24 | 36 | 41 | 43 | 52 | 69 | 54 | 52 | 100 | 92 | 19 | 69 |
| bCE | 32 | 27 | 0 | 32 | 38 | 21 | 50 | 24 | 35 | 27 | 83 | 100 | 23 | 30 |
| ppL | 1 | 1 | 2 | 20 | 21 | 20 | 10 | 18 | 12 | 100 | 4 | 7 | 4 | 4 |
| RML | 2 | 18 | 6 | 33 | 42 | 30 | 28 | 33 | 26 | 100 | 23 | 3 | 35 | 0 |
| PAF-AH | 8 | 14 | 12 | 29 | 14 | 13 | 55 | 13 | 14 | 35 | 52 | 72 | 100 | 45 |

Enzymes:
PCL Pseudomonas cepacia lipase (D. Guieysse et al., Tetrahedron: Asymmetry 2003, 14 1807-1817; C. Gentner et al., Colloids and Surfaces B: Biointerfaces 2002, 26 57-66)
PCL W: Pseudomonas cepacia lipase L287W (C. Gentner et al., Colloids and Surfaces B: Biointerfaces 2002, 26 57-66)
PSL: Pseudomonas species lipase
psLPL: Pseudomonas species lipoprotein lipase
EP6: Burkholderia gladioli esterase B (E. I. Petersen et al., Journal of Biotechnology 2001, 89 11-25)
MME: Mucor mihei esterase (M. Karra-Chaabouni et al., Biotechnology Letters 2004, 24 1951-1955)
EP10: Burkholderia gladioli esterase A
CAL A: Candida antarctica lipase A (M. Martinelle et al., Biochimica et Biophysica Acta (BBA) - Lipids and Lipid Metabolism 1995, 1258 272-276; S. Hari Krishna et al., Tetrahedron: Asymmetry 2002, 13 2693-2696)
ANL: Aspergillus niger lipase
ROL: Rhizopus oryzae lipase
ROL F: Rhizopus oryzae lipase L258F/L254F
bLPL: lipoprotein lipase from bovine milk (R. Zechner, Biochimica et Biophysica Acta (BBA) - Lipids and Lipid Metabolism 1990, 1044 20-25)
FSC: fusarium solari cutinase (S. Longhi et al., Biochimica et Biophysica Acta (BBA) - Molecular and Cell Biology of Lipids 1999, 1441 185-196; C. M. Carvalho et al., Biotechnol.Bioeng. 1999, 66 17-34)
ppCE: porcine pancreatic cholesterol esterase (J. C. Chen et al., Biochemistry 1998, 37 5107-5117)
bCE: bovine pancreatic cholesterol esterase (J. C. Chen et al., Biochemistry 1998, 37 5107-5117)
ppL: porcine pancreatic lipase (M. P. Egloff et al., Biochemistry 1995, 34 2751-2762; P. Ciuffreda et al., Chemistry and Physics of Lipids 2001, 111 105-110)
RML: Rhizomucor mihei lipase (A. M. Brzozowski et al., Nature 1991, 351 491-494)
EX9: Xanthomonas vesicatoria esterase E
PAF-AH: human recombinant platelet activating factor acetyl hydrolase

1. Assay library comprising the following fluorescently labeled phosphonate esters: 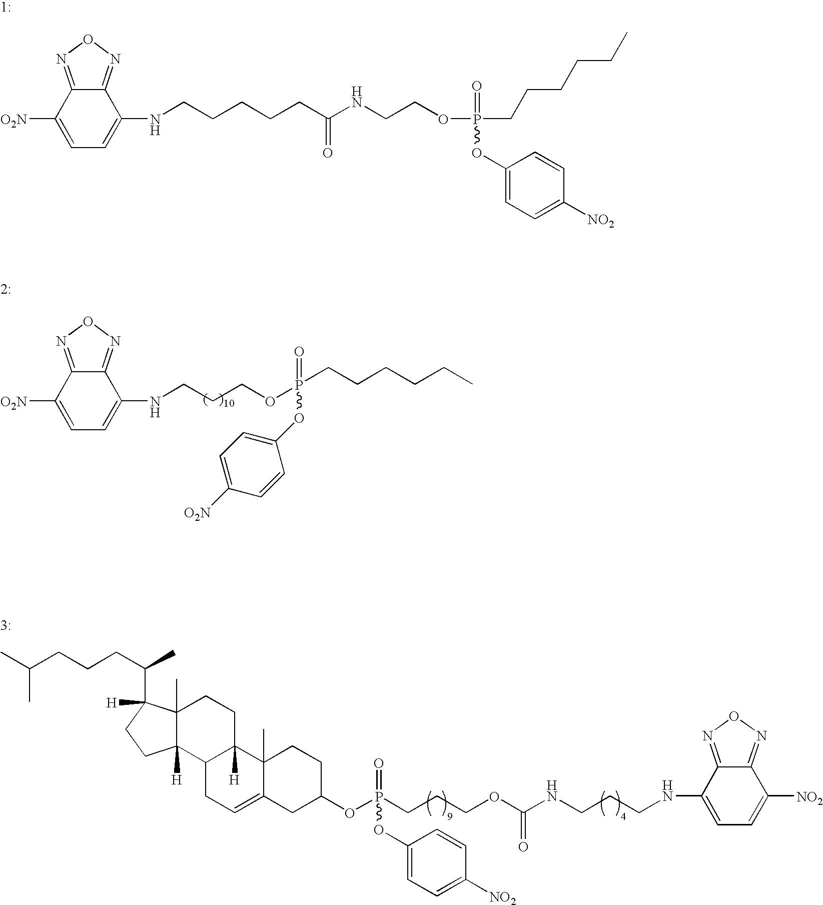
4: S-configurated (sn1) diastereomer 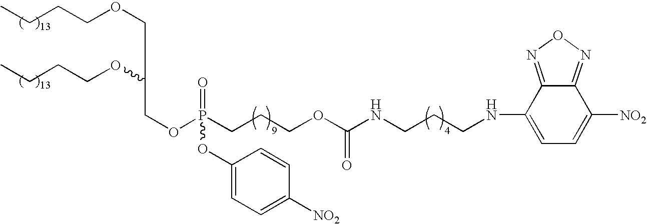
5: R-configurated (sn3) diastereomer 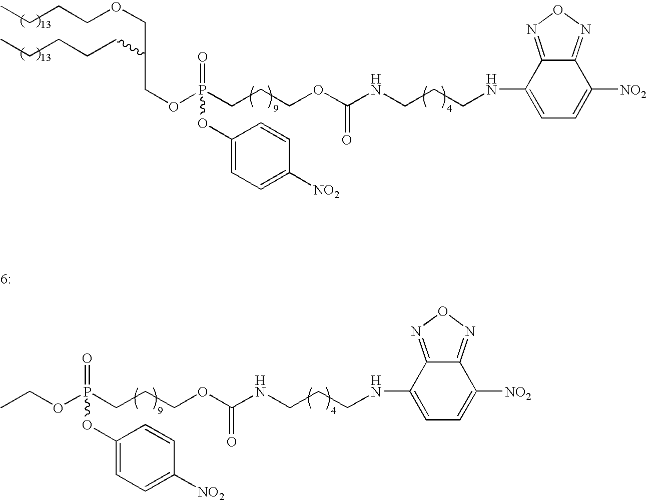
7: S-configurated (sn1) diastereomer 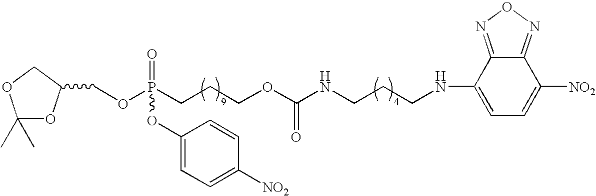
8: R-configurated (sn3) diastereomer 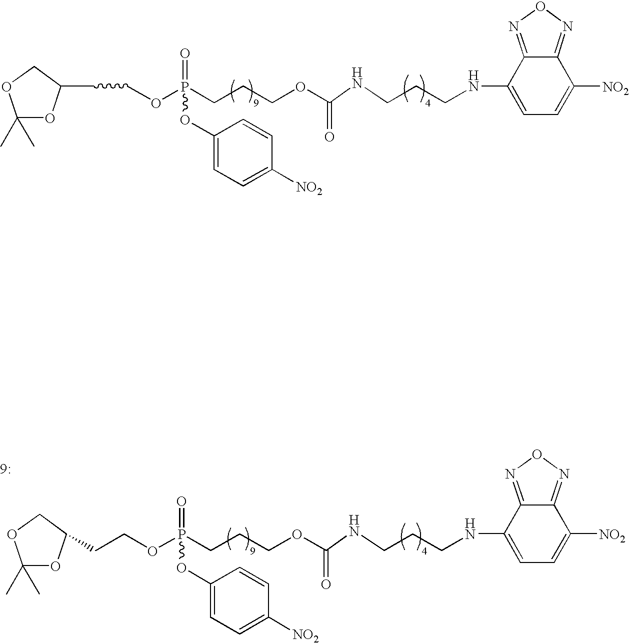
10: S-configurated diastereomer 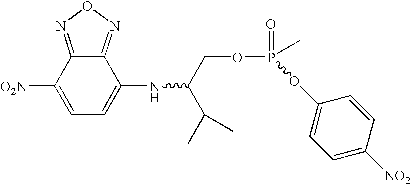
11: R-configurated diastereomer 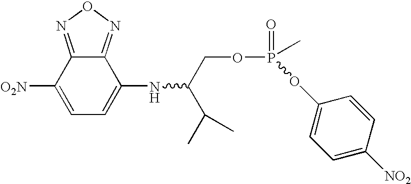
12: S-configurated diastereomer 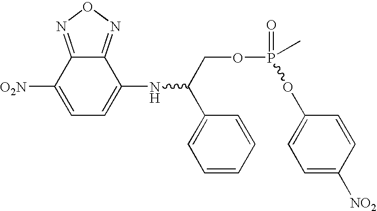
13: R-configurated diastereomer

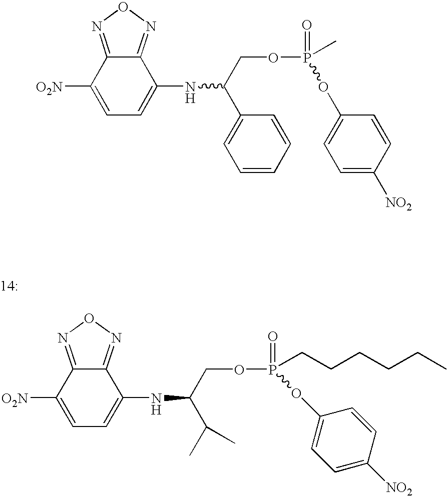

2. Use of the assay library according to claim 1 for activity based identification and characterization of serine hydrolases.

3. Use according to claim 2, wherein the serine hydrolases are lipases and/or esterases.

4. A process for discriminating serine hydrolase activities, in particular lipase and esterase activities, comprising the steps of incubating the fluorescently labeled phosphonate esters of the assay library according to claim 1 individually with an enzyme sample to be probed in the presence of a detergent, preferably 1 mM Triton X-100, subjecting the mixture to SDS-PAGE and imaging fluorescence to determine the extent of enzyme inhibition.
